(19) United States
(12) Patent Application Publication
(10) Pub. No.: US 2026/0029356 A1
(43) Pub. Date: Jan. 29, 2026

(54) MOBILE IMAGING UNIT

(71) Applicant: CGS Premier, Inc., Muskego, WI (US)

(72) Inventors: Benjamin Robert Schumann, Racine, WI (US); Bradley Raymond Thomas, Wind Lake, WI (US); Gregory Richard Peterson, Oconomowoc, WI (US)

(21) Appl. No.: 19/276,870

(22) Filed: Jul. 22, 2025

Related U.S. Application Data
(60) Provisional application No. 63/674,506, filed on Jul. 23, 2024.
(60) Provisional application No. 63/725,160, filed on Nov. 26, 2024.

(51) Int. Cl. G01N 23/046; B62D 63/06; B62D 63/08

(52) U.S. Cl. CPC G01N 23/046; B62D 63/061; B62D 63/08; G01N 2223/108; G01N 2223/301; G01N 2223/419

(57) ABSTRACT

A mobile imaging unit configured for transport between a first location and a second location, the mobile imaging unit includes a base configured to rest upon a ground surface that is external to the mobile imaging unit, the base extending from the ground surface to a floor of the mobile imaging unit, a plurality of walls extending upward from the base to define an interior of the mobile imaging unit therebetween, the interior of the mobile imaging unit having an imaging room housing an imaging unit, and a control room having a workstation from which the imaging unit is controllable, wherein the plurality of walls includes a movable wall, a track coupled to the base, and a caster coupled to the movable wall and movable with the wall along the track from a stowed position to an installed position to increase a width of the mobile imaging unit.

### CROSS-REFERENCE TO RELATED APPLICATIONS

This application claims priority to U.S. Provisional Application No. 63/674,506, filed on Jul. 23, 2024 and U.S. Provisional Application No. 63/725,160, filed on Nov. 26, 2024, the entire contents of each of which are incorporated herein by reference.

### BACKGROUND OF THE INVENTION

Imaging units, such as scanners used by medical professionals, are often located within medical facilities such as hospitals and clinics. In some instances, medical facilities may lack scanners or may desire to acquire the use of additional scanners. Mobile imaging units according to the state of the art are wheeled semi-trailer units driven via a truck (e.g., a semi-truck) and parked on location in a parking lot or other nearby lot of the medical facility. Housed therein is a scanner for use by medical professionals. The imaging units according to the state of the art have deficiencies overcome by the mobile imaging unit described herein.

### SUMMARY OF THE INVENTION

A mobile imaging unit is removable from the trailer and placed at ground level to eliminate tall/steep ramps or steps into and out of the unit, which provides for easier entry and egress for elderly patients and patients with disabilities. The floor or base of the unit has sufficient rigidity to prevent movement of the scanner within the unit during the removal of the unit from the trailer and return of the unit to the trailer. The rigidity of the base also prevents significant twisting and distortion of the unit under the weight of the scanner and the multiple walls, many of which are lead-lined walls. The unit is expandable beyond the normal width of a trailer. Based on the increased weight of the lead-lined walls, typical accordion-style expansion may not be feasible, and as such, a track system is implemented to facilitate movement of the walls. Additional track systems may be utilized elsewhere within the system to facilitate movement of other walls (i.e., interior walls). The unit includes multiple rooms, including the imaging room, the control room/entryway, a dosing room, and three uptake rooms. By incorporating three uptake rooms, the unit is capable of timely accommodation of Biograph Trinion PET/CT scanning, where the uptake process can take an hour, while the scanning takes only 15 to 20 minutes.

In some aspects, the techniques described herein relate to a mobile imaging unit configured for transport between a first location and a second location, the mobile imaging unit including: a base configured to rest upon a ground surface that is external to the mobile imaging unit, the base extending from the ground surface to a floor of the mobile imaging unit; a plurality of walls extending upward from the base to define an interior of the mobile imaging unit therebetween, the interior of the mobile imaging unit having an imaging room housing an imaging unit, and a control room having a workstation from which the imaging unit is controllable, wherein the plurality of walls includes a movable wall; a track coupled to the base; and a caster coupled to the movable wall and movable with the movable wall along the track from a stowed position to an installed position to increase a width of the mobile imaging unit.

In some aspects, the techniques described herein relate to a mobile imaging unit, wherein the track is a first track and the caster is a first caster, the mobile imaging unit further including a second track coupled to the base and extending parallel to the first track, and a second caster coupled to the movable wall and movable along the second track from the stowed position to the installed position.

In some aspects, the techniques described herein relate to a mobile imaging unit, wherein, in the installed position, the caster is coupled to the movable wall and spaced apart from the track

In some aspects, the techniques described herein relate to a mobile imaging unit, wherein, in the installed position, the caster is located outside of the interior of the mobile imaging unit.

In some aspects, the techniques described herein relate to a mobile imaging unit, wherein, when the caster is in the stowed position, the movable wall is spaced apart from the base, and when the caster is in the installed position, the movable wall is in direct contact with the base.

In some aspects, the techniques described herein relate to a mobile imaging unit, wherein the movable wall is located within the interior of the mobile imaging unit when the caster is in the stowed position, and wherein the movable wall is an exterior wall at least partially defining an extent of the interior of the mobile imaging unit in the installed position.

In some aspects, the techniques described herein relate to a mobile imaging unit, wherein a first portion of the track is located within a first portion of the floor and a second portion of the track is located within a second portion of the floor, wherein the second portion of the floor is rotatable relative to the first portion of the floor.

In some aspects, the techniques described herein relate to a mobile imaging unit, wherein the caster is located within the first portion of the track in the stowed position, and wherein the caster is configured to pass over the second portion of the track to reach the installed position.

In some aspects, the techniques described herein relate to a mobile imaging unit, wherein the plurality of walls includes a wall section coupled to the base when the movable wall is in the installed position, the wall section coupling the movable wall to a remainder of the plurality of walls.

In some aspects, the techniques described herein relate to a mobile imaging unit, further including a bracket coupling the wall section to the movable wall to secure the movable wall in the installed position.

In some aspects, the techniques described herein relate to a mobile imaging unit, wherein the interior of the imaging unit further includes a plurality of uptake rooms, each of the plurality of uptake rooms having a seat for a user of the mobile imaging unit to wait for a radiotracer to travel through the user to a location that is to be scanned by the imaging unit, wherein the movable wall at least partially defines an extent of an interior of the plurality of uptake rooms in the installed position.

In some aspects, the techniques described herein relate to a mobile imaging unit configured for transport between a first location and a second location, the mobile imaging unit including: a base configured to rest upon a ground surface that is external to the mobile imaging unit, the base extending from the ground surface to a floor of the mobile imaging unit, the base having a first footprint when transported from the first location to the second location and a second footprint when in an installed position; a plurality of walls extending upward from the base to define an interior of the mobile imaging unit therebetween, the interior of the mobile imaging unit having: an imaging room housing an imaging unit for a patient; a control room having a workstation from which the imaging unit is controllable; and a plurality of uptake rooms, each of the plurality of uptake rooms having a seat for the patient to wait for a radiotracer to travel through the patient to a location that is to be scanned by the imaging unit; and an extension forming a portion of the interior of the mobile imaging unit that extends outward from the first footprint of the base, the extension movable relative to a remainder of the mobile imaging unit between a stowed position and an installed position.

In some aspects, the techniques described herein relate to a mobile imaging unit, wherein the extension includes a movable wall of the plurality of walls, the movable wall being movable between a stowed position and an installed position via a caster coupled to the movable wall.

In some aspects, the techniques described herein relate to a mobile imaging unit, wherein the movable wall at least partially defines an extent of an interior of the plurality of uptake rooms in the installed position.

In some aspects, the techniques described herein relate to a mobile imaging unit, wherein at least a portion of the extension is coupled to the base within the interior of the first footprint when transported from the first location to the second location

In some aspects, the techniques described herein relate to a method of assembling a mobile imaging unit from a transport position to a use position, the method including: transporting the mobile imaging unit from a first location to a second location and resting a base of the mobile imaging unit on a ground surface at the second location; raising a wall of the mobile imaging unit to form a ceiling of an extension; lowering a surface within the mobile imaging unit to form a floor of the extension; sliding a wall on casters along the floor of the extension from a location within an interior of the mobile imaging unit to an edge of the floor of the extension to form an external wall of the extension, thereby increasing a footprint of the mobile imaging unit in the use position relative to the transport position.

In some aspects, the techniques described herein relate to a method, wherein the wall that is raised to form the ceiling of the extension is an external wall of the mobile imaging unit when the mobile imaging unit is transported from the first location to the second location.

In some aspects, the techniques described herein relate to a method, wherein sliding the wall on casters includes moving the casters along a track formed at least partially within the floor of the extension.

In some aspects, the techniques described herein relate to a method, wherein the track extends into a floor of the mobile imaging unit that is separate from the extension such that moving the casters along the track includes moving the casters from the floor of the mobile imaging unit that is separate from the extension onto the floor of the extension.

In some aspects, the techniques described herein relate to a method, further including sliding the casters off of the floor of the extension to lower the wall onto the floor of the extension.

### BRIEF DESCRIPTION OF THE DRAWINGS

FIG. 1 is a plan view of a mobile imaging unit.

FIG. 2 is a perspective view of the mobile imaging unit of FIG. 1.

FIG. 3 is a plan view of the mobile imaging unit of FIG. 1 illustrating the lead shielding of various walls.

FIG. 4 is a second perspective view of a front of the mobile imaging unit of FIG. 1.

FIG. 5 is a third perspective view of a front of the mobile imaging unit of FIG. 1.

FIG. 6 is a top-down perspective view of the interior of the mobile imaging unit of FIG. 1.

FIG. 7 is a perspective view of a control room/entryway, an imaging room, and an uptake room of the mobile imaging unit of FIG. 1.

FIG. 8 is a perspective view of the imaging room of the mobile imaging unit of FIG. 1.

FIG. 9 illustrates a plan view of the imaging unit of FIG. 1.

FIG. 10 is a side view of a caster for moving a wall of an extension of the mobile unit of FIG. 1.

FIG. 11 is a front view of the caster of FIG. 10.

FIG. 12 is a perspective view of the caster of FIG. 10.

FIG. 13 is a top view of the caster of FIG. 10.

FIG. 14 illustrates a track for the caster of FIGS. 10-13.

FIG. 15 illustrates a plan view of the imaging unit of FIG. 1 during assembly of the extension of the mobile unit.

FIG. 16 is a side view of the caster in the installed position.

FIG. 17 is a further side view of the caster in the installed position.

FIG. 18 illustrates trim shielding for the extension of the mobile unit of FIG. 1.

FIG. 19 illustrates a front view of an interior wall of the mobile unit of FIG. 1 having the trim shielding of FIG. 18.

FIG. 20 illustrates an installation step in which a ceiling of the mobile unit of FIG. 1 is propped upward.

FIG. 21 illustrates an awning support bracket for supporting the ceiling in a raised position.

FIG. 22 illustrates an installation step in which a floor of the extension is lowered.

FIG. 23 illustrates the floor of the extension in the lowered position.

FIG. 24 illustrates the caster relative to the lowered floor of the extension.

FIG. 25 illustrates the mounting point for a caster.

FIG. 26 illustrates the caster in an installed position of the outer wall.

FIG. 27 illustrates an attachment point for the outer wall for attaching to the lowered floor.

FIG. 28 illustrates an installation step in which a sidewall of the extension is moved into place adjacent the floor and outer wall.

FIG. 29 illustrates an interior hinge between two wall sections that facilitates rotation of one wall relative to another between a folded position and a deployed position.

FIG. 30 illustrates the interior hinge in the deployed position.

FIG. 31 illustrates the walls of the extension mounted on the floor.

FIG. 32 illustrates a further perspective view of the walls of the extension mounted on the floor.

FIG. 33 illustrates a plan view of the mobile unit of FIG. 1 in the transport position with a smaller footprint for travel.

FIG. 34 is a schematic representation of the mobile unit of FIG. 1 in the transport position on a vehicle for transporting the mobile unit from a first location to a second location.

FIG. 35 is a schematic representation of the mobile imaging unit of FIG. 1 lowered onto a ground surface.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

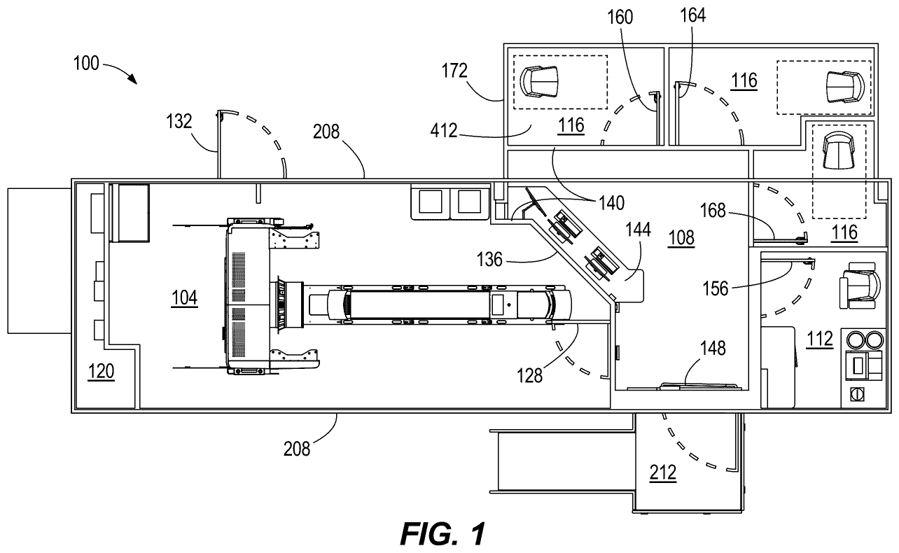

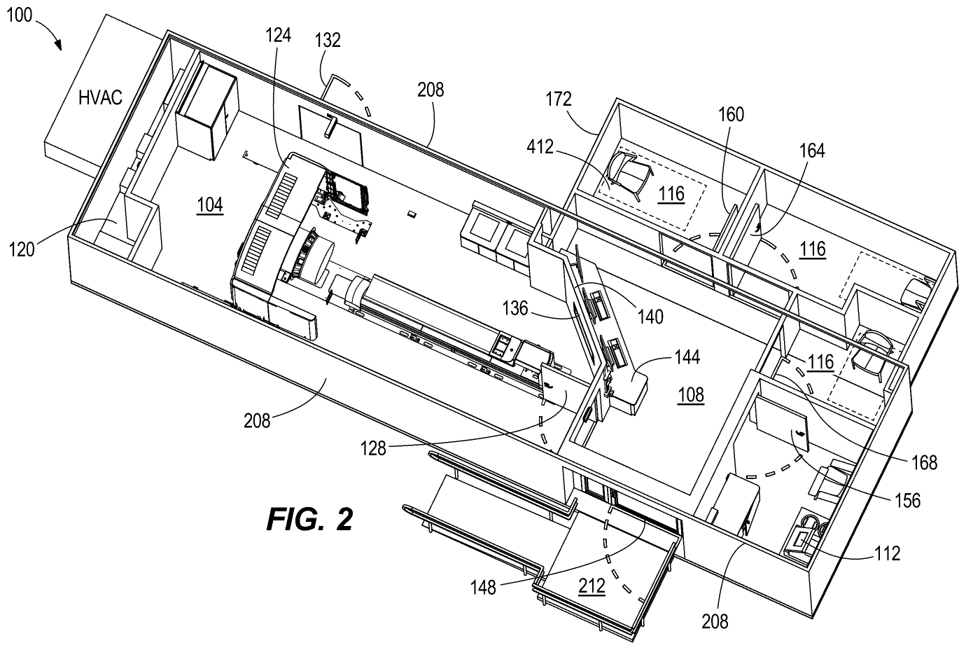

A mobile imaging unit 100 is illustrated in FIGS. 1-2 and includes an imaging room 104, a control room 108, a dosing room 112 and multiple uptake rooms 116. The control room 108 is centrally located such that each of the imaging room 104, the dosing room 112 and the multiple uptake rooms 116 are accessible via the control room 108. Additionally, a closet 120 (e.g., an electrical closet, a heating, ventilation, and air conditioning closet, or a combination of the same) is provided to the rear of the imaging room 104 accessible via the imaging room 104 or via an exterior access point.

The imaging room 104 is generally elongated to accommodate the elongated length of the scanner 124 located therein. As shown, the scanner 124 is a positron emission tomography (PET) and computed tomography (CT) scanner. In other embodiments, other scanners (e.g., ultrasound scanners, magnetic resonance imaging scanners, etc.) may be located within the imaging room 104, though various aspects of the imaging unit 100 may require modifications to accommodate the size, weight, and radioactivity of other scanners. The imaging room 104 includes a door 128 through which a patient (i.e., a user of the mobile imaging unit 124) enters the imaging room 104 from the control room 108. In some embodiments, a further door 132 or other egress is provided (e.g., on a rear side of the imaging unit 100) as a secondary exit from the imaging room 104 (e.g., to an exterior of the imaging unit 100). An interior window 136 is provided within an interior wall 140 that separates the control room 108 from the imaging room 104 such that an operator of the scanner 124 (e.g., technologist) has a line of sight from a workstation 144 within the control room 108 to the scanner 124 and the patient using the scanner 124.

The control room 108 is the room from which the technologist operates the scanner 124. Additionally, the control room 108 is the entryway and central hub through which the technologist and patients access the various other rooms 104, 112, 116 of the unit 100. The door 128 is a first door provided within a wall of the control room 108. A main entrance door 148 provides access between the control room 108 and the environment outside of the imaging unit 100 (e.g., to a front walkway or porch 212). A dosing room door 156 provides access between the control room 108 and the dosing room 112. First, second, and third uptake doors 160, 164, 168 provide access between the control room 108 and the first, second, and third uptake rooms 116, respectively. The workstation 144 includes a desk, a computer, and other electronics necessary to operate the scanner 124 from within the control room 108 and is located at and below the window 136.

The dosing room 112 is located opposite the imaging room 104 such that the control room 108 is positioned between the imaging room 104 and the dosing room 112. The dosing room 112 includes a seat for a patient, a storage cabinet, and the necessary medical equipment to inject a radiotracer into the patient prior to use of the scanner 124. The three uptake rooms 116 are waiting rooms in which the patient can allow the radiotracer to travel through the body of the patient to the location that is to be scanned. As such, the uptake rooms 116 include a seat or other resting surface for the patient. By incorporating three uptake rooms 116 into the imaging unit 100, a one-hour wait time can be simultaneously accomplished by three patients, especially in view of Biograph Trinion PET/CT scanning, which may only take 15 to 20 minutes. By staggering the entry into the uptake rooms 116 by twenty minutes (e.g., a second patient enters the second uptake room twenty minutes after a first patient enters the first uptake room and a third patient enters the third uptake room twenty minutes after the second patient enters the second uptake room), the scanner 124 can be in a substantially constant state of use with little downtime. In contrast, if the imaging unit 100 only included a single uptake room 116, only a single patient could prepare for scanning, resulting in substantial downtime of the scanner 124.

In the embodiment shown in FIG. 1, the imaging room 104 is large and elongated to accommodate the length of the scanner 124. The control room 108 is positioned adjacent the imaging room 104 but is offset from the imaging room along the longitudinal direction such that the width of the imaging room (perpendicular to the longitudinal length) is the full width of the trailer (excepting for the extension 172 discussed in greater detail below). The dosing room 112 and at least one of the uptake rooms 116 is located longitudinally to one side of the control room 108. As such, a longitudinal axis of the imaging unit 100 extends through the imaging room 104, then through the control room 108, then through one or both of the uptake room 116 and the dosing room 112.

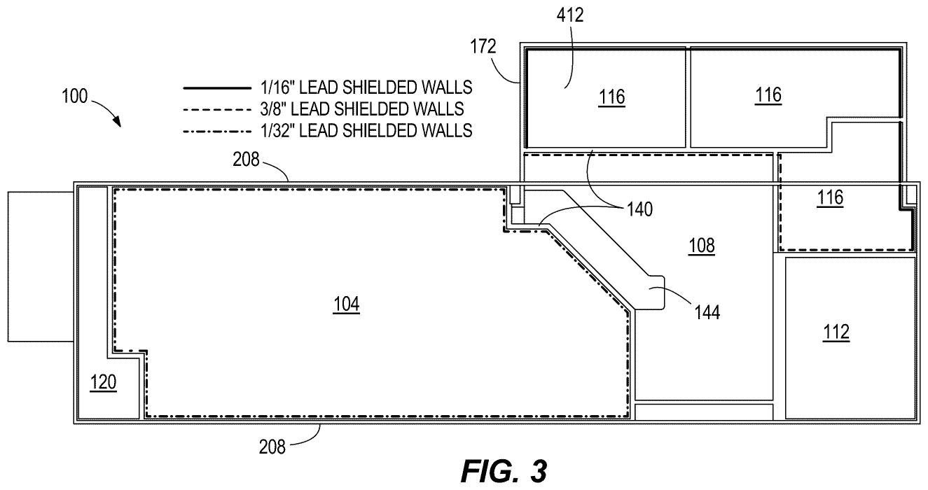

FIG. 3 illustrates lining and shielding of the walls to limit radioactivity transmission from the imaging unit 100 and from one portion of the imaging unit 100 to another. The walls of the imaging room 104 include a 1/32″ lead lining. The exterior walls of the uptake rooms 116 (i.e., the walls that separate the uptake rooms 116 from an exterior of the imaging unit 100) include a 1/16″ lead lining. The interior walls of the uptake rooms 116 (i.e., the walls that separate the uptake rooms 116 from the control room 108 and the dosing room 112) include a ⅜″ lead lining. The doors in the respective walls discussed above are similarly lead-lined.

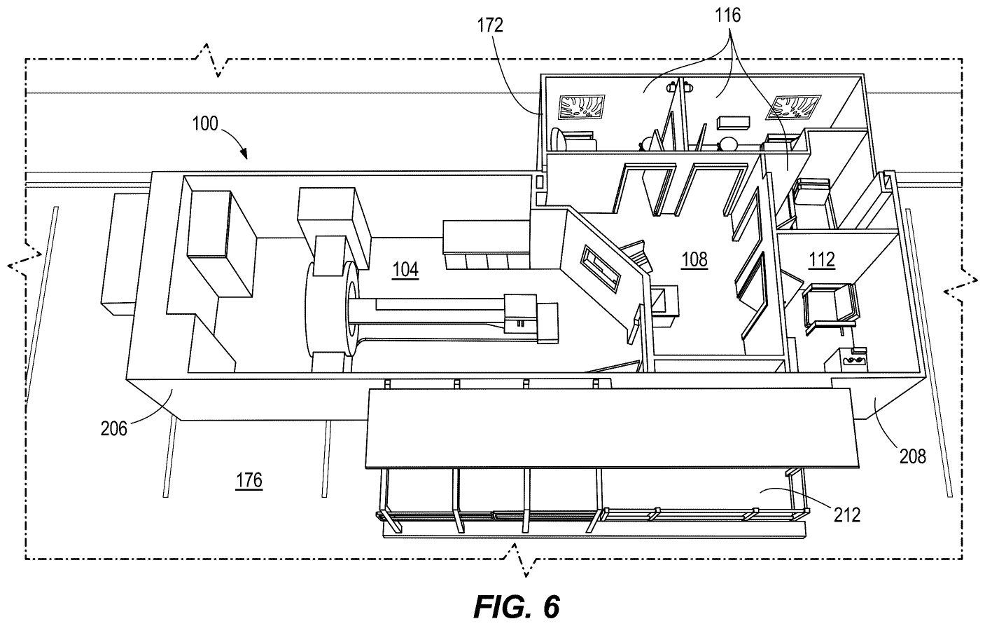

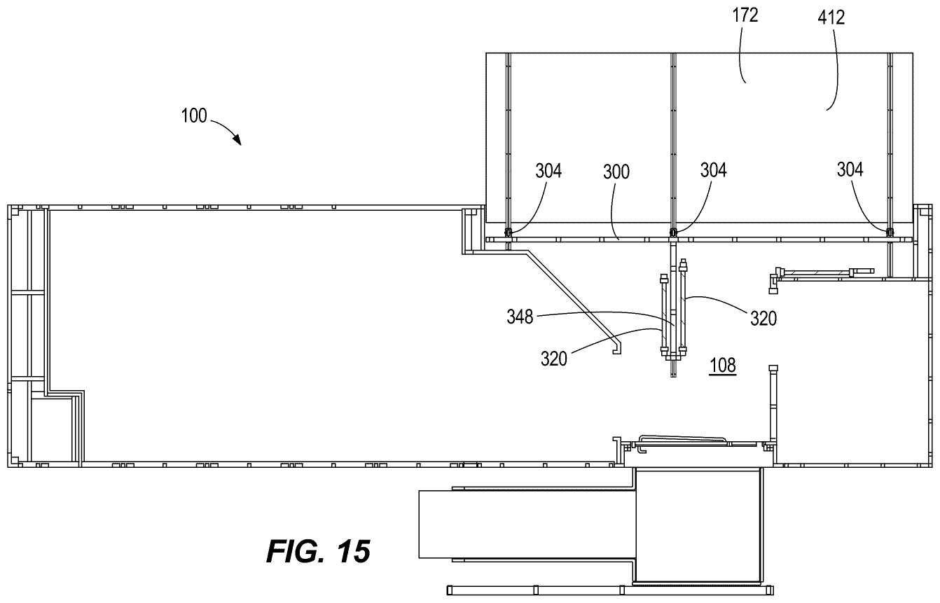

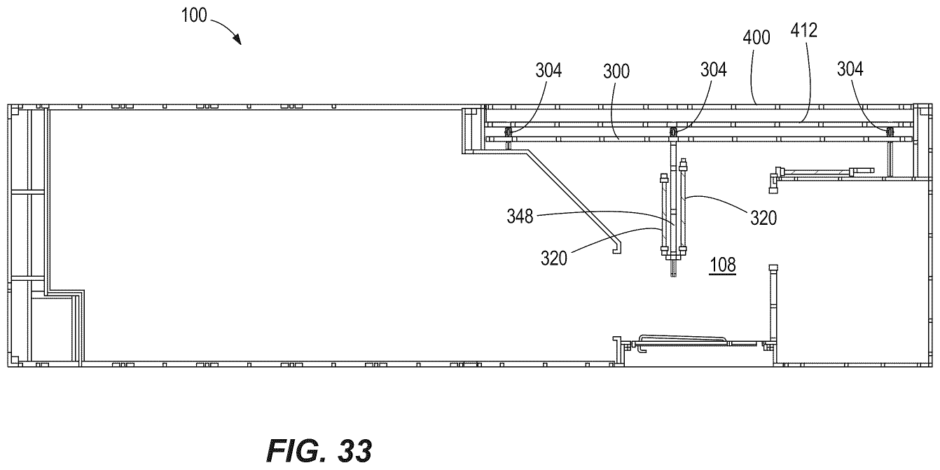

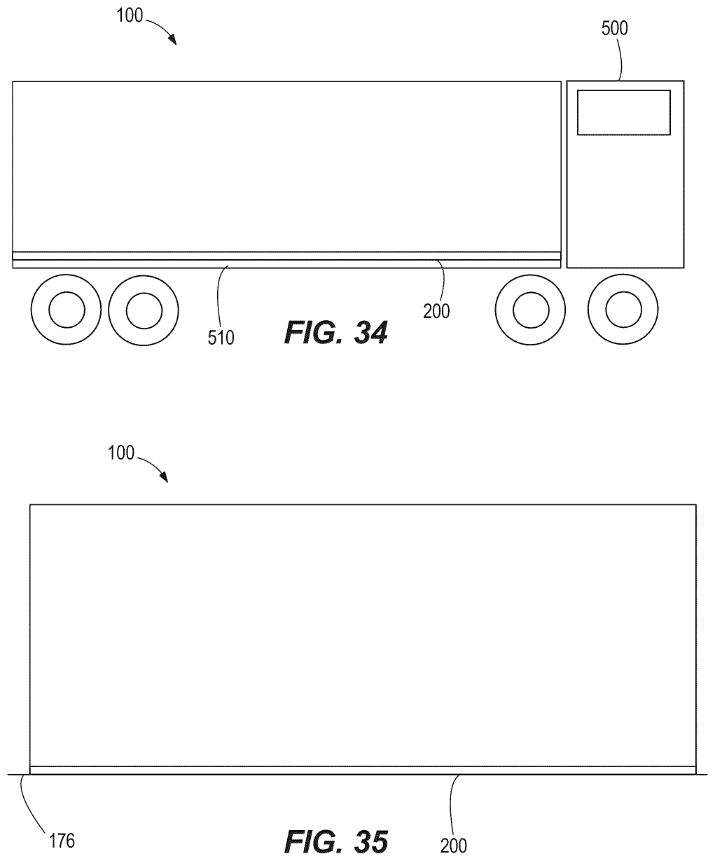

At least some of the imaging unit 100 extends beyond the typical rectangular footprint (i.e., the outer periphery as shown in FIG. 33) of a trailer. As shown in FIGS. 1-6, an entirety of two of the uptake rooms 116, a portion of the third uptake room 116, and a portion of the control room 108 extend outside of the normal footprint and are formed as an extension 172. The footprint of the imaging unit 100 when in transport is a smaller, first footprint to fit on the trailer 510 (FIG. 34), as shown in FIG. 33, and is an increased, second footprint (i.e., the outer periphery as shown in FIG. 1) when in an installed, use position to provide increased square footage for the interior of the imaging unit 100. In contrast to expansions known in the prior art that use, for example, accordion-style expanding walls to increase an interior footprint (e.g., of a mobile home), the weight of the lead-lined walls prohibits such mechanisms. As such, the imaging unit 100 includes tracks in which the walls of the extension 172 are slidable (e.g., linearly slidable) to support the weight of the walls. In some embodiments, tracks 308 (FIGS. 14-15) are embedded into a floor surface 412, a ceiling surface 400, or both. In some embodiments, the floor 412 and the ceiling 400 fold outward and the walls slide therebetween. In other embodiments, an entirety of the walls (such as walls 140, 208, 300, 428, 436, 440), floor 412, and ceiling 400 of the extension 172 slide collectively outward relative to a floor and ceiling of the remainder of the imaging unit 100.

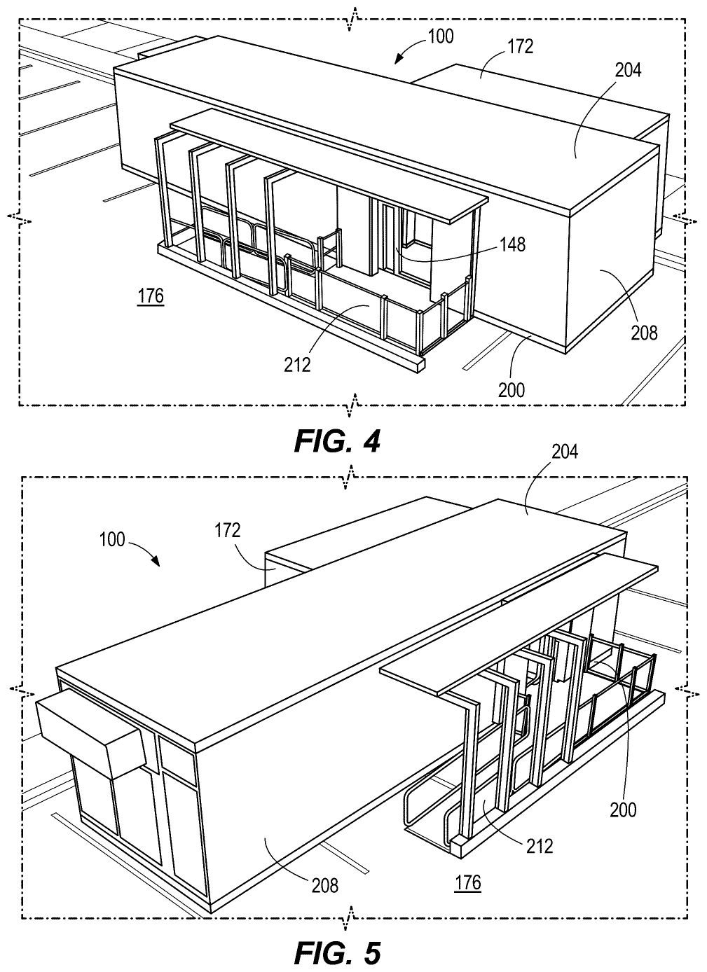

FIGS. 4-6 illustrate the exterior of the imaging unit 100. As shown, the imaging unit 100 is located directly on a ground surface 176 that is external to the imaging unit 100. In some embodiments, the ground surface 176 is a parking lot of a medical facility utilizing the imaging unit 100. In other embodiments, the ground surface 176 is a purpose-built slab (e.g., concrete slab). By locating the imaging unit 100 on the ground surface 176, steep ramps or steps are unnecessary or are of substantially decreased height, as compared to imaging units that remain mounted to a truck. A hydraulic system known in the art may be used to remove and lower the imaging unit 100 from a transport/trailer 500 (FIG. 34) to the ground surface 176 (FIG. 35).

The imaging unit 100 includes a base 200 that rests upon the ground surface 176, with the floor 412 forming the upper surface of the base 200. The base 200 has sufficient rigidity to support the weight of the scanner 124 and to prevent movement and torsion of the scanner 124 when lowering the imaging unit 100 from a bed 510 or trailer of the transport 500 to the ground surface 176 and subsequently raising the imaging unit 100 from the ground surface 176 back onto a transport. A ceiling 204 extends above the base 200 and a plurality of interior walls 140 and exterior walls 208 connect the ceiling 204 to the base 200.

With continued reference to FIGS. 4-6, the exterior walls 208 and ceiling can include architectural features, such as a raised entryway. In some embodiments, the architectural features can be modified to match an appearance of the medical facility. Other elements of the exterior include a covered porch 212 and planter boxes. The porch 212 leads to the main entrance 148 and may fold out from a transport position (FIG. 33) adjacent an exterior wall 208 of the imaging unit 100 to a use position. As shown, the porch 212 includes a slight incline from the ground surface 176 to the main entrance 148 to accommodate for the thickness of the base 200. In embodiments which incorporate planter boxes or other decorative elements, the planter boxes substantially cover the base 200 along a majority of the front side of the imaging unit 100 to provide an impression of a permanent installation.

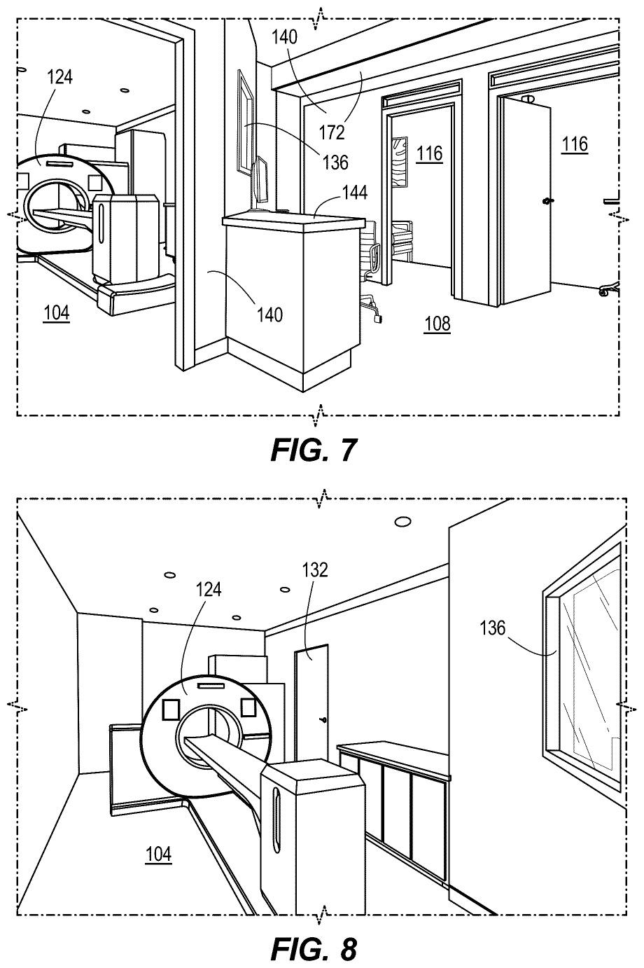

FIGS. 7-8 illustrate an interior of the imaging unit 100 with FIG. 7 illustrating a view from adjacent the main entrance 148 within the control room 108 and FIG. 8 illustrating a view of the scanner 124 from adjacent the door 128 between the imaging room 104 and the control room 108.

In assembly, the imaging unit 100 is transported (e.g., via a semi-trailer 500) to a desired ground surface 176, such as a concrete pad or a parking lot of a medical facility. As the imaging unit 100 is sized to fit on a semi-trailer (with the extension 172 stowed), the imaging unit 100 is configured for transport between a first location (e.g., a parking lot or concrete pad outside of a first medical facility) and a second location (e.g., a parking lot or concrete pad outside of a first medical facility). The imaging unit 100 is lowered to the ground surface 176 using known hydraulic devices/systems such that the truck and trailer are no longer between the imaging unit 100 and the ground surface 176. The extension 172 is moved (e.g., slid along tracks) into place to increase the interior footprint of the imaging unit 100. In some embodiment, internal walls 140 are also moved to form the various rooms 104, 108, 112, 116. Any lead lining that is not permanently affixed to the walls and doors can be affixed once the imaging unit 100 is positioned on the ground surface 176 and the walls are moved to their final operating positions. The porch 212 is moved into position to provide access to the main entrance 148.

In use, a patient is injected with a radiotracer (or otherwise assisted if the scanner 124 is an alternative type of imaging device) in the dosing room 112 and is relocated to an uptake room 116. After an appropriate time period (e.g., 60 minutes) of waiting has elapsed for the radiotracer to move throughout the body, the patient is brought through the control room 108 to the scanning room to be imaged by the scanner 124. The technologist operates the scanner 124 from the workstation 144, viewing the patient through the interior window 136. Upon completion of the scan, the patient leaves the imaging unit 100 through the main entrance 148.

In disassembly, the porch 212 is removed or moved into the transport position (FIG. 33) and the extension 172 is moved along its tracks into a retracted position. Interior walls 140 may additionally be moved to accommodate these changes. Some lead lining may be removed if needed to collapse/move any interior walls. The imaging unit 100 is lifted onto a trailer using the hydraulic devices to be transported (e.g., via a semi-trailer 500) away from the medical facility.

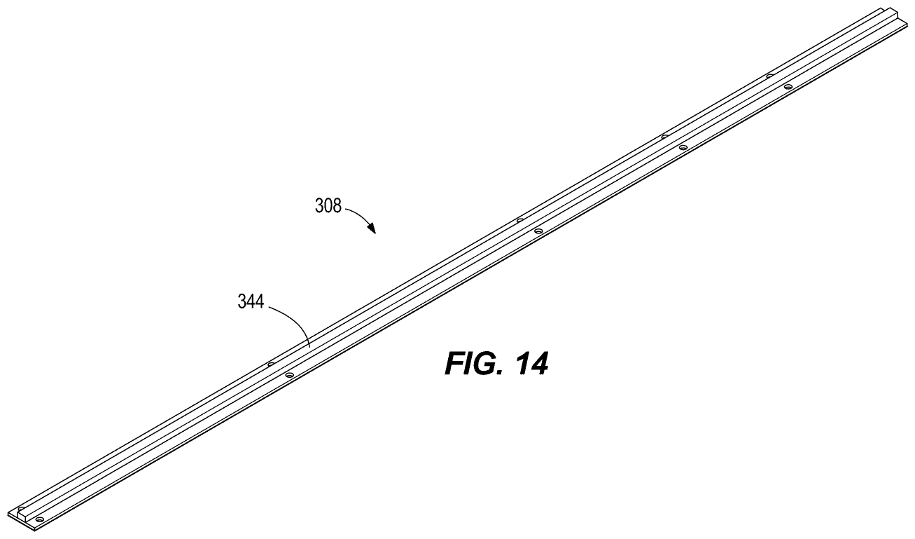

FIG. 9 illustrates a plan view of the mobile imaging unit 100 and specifically illustrates further aspects of the mobile imaging unit 100. A wall 300 of the extension 172 is movable relative to the remainder of the imaging unit 100 via casters 304 (e.g., at least two casters, at least three casters, at least four casters). The casters 304 ride along parallel tracks 308 that extend into the extension 172 and the control room 108. FIG. 13 also illustrates T-brackets 312 and L-brackets 316 mounted to a top edge of adjacent walls of the extension 172 to secure the adjacent walls to one another. Further still, FIG. 13 illustrates shielded (e.g., lead lined) doors 320 located between the control room 108 and the uptake rooms 116.

With continued reference to FIG. 9, the T-brackets 312 are located at the junction between two walls of the extension that extend perpendicular to one another, with only one of the two walls terminating at the juncture. The L-brackets 316 are located at the corner where two walls meet and terminate. The brackets 312, 316 are formed of, for example, thin (e.g., ¼″, ½″) plate metal (e.g., steel, aluminum) and are affixed to the tops of the adjacent walls via threaded fasteners that extend into threaded openings in the walls. The brackets 312, 316 correspond in size and shape to the upper profile of the walls so as to not extend beyond the walls. The brackets 312, 316 strengthen the connections between the walls and prevent racking, especially in high winds.

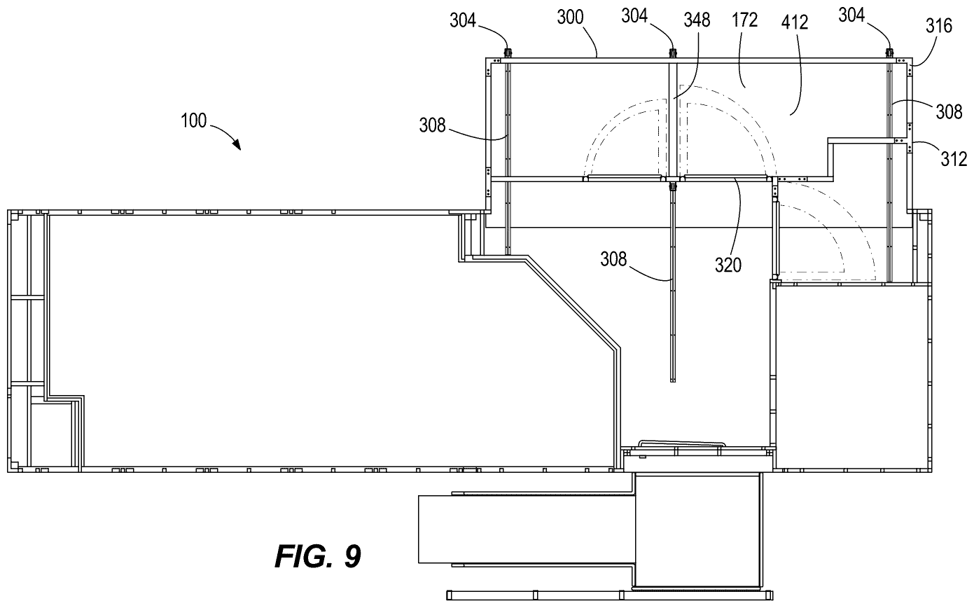

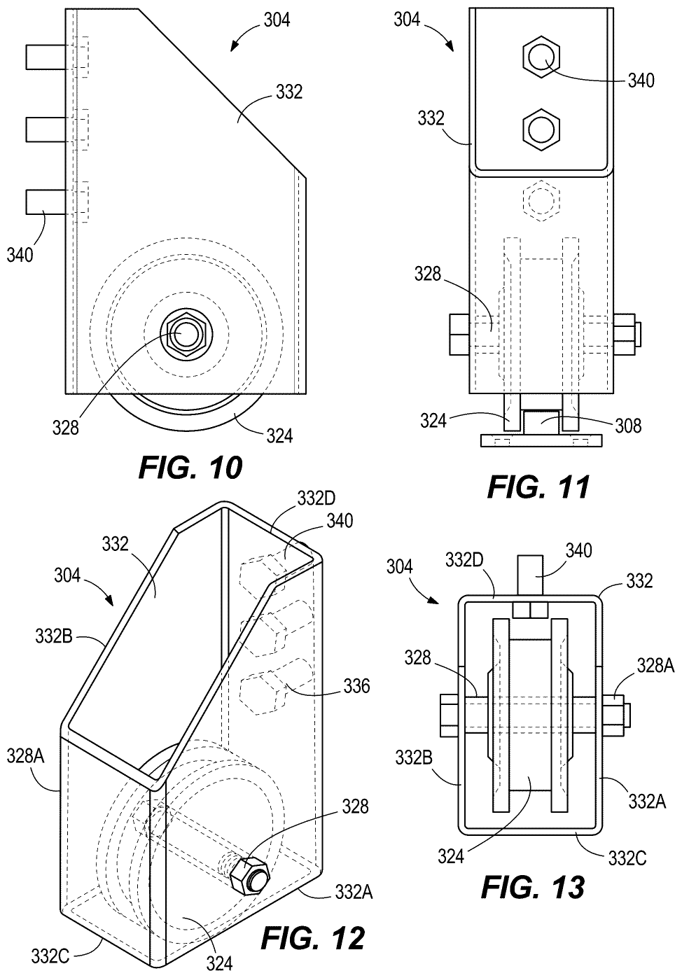

FIGS. 10-13 illustrate the casters 304 for moving the wall 300 of the extension 172 in greater detail. Each caster 304 includes a caster wheel 324 rotatable about an axis defined by an axle 328. The axle 328 is supported by opposing first and second sidewalls 332A, 332B of a cage 332. In some embodiments, the axle 328 is secured to the cage 332 via a nut 328A. The sidewalls 332A, 332B are connected to one another via a front wall 332C and a rear wall 332D, the four walls 332A-D forming a cage surrounding the caster wheel 324 on four sides (though the cage 332 is open on a top side and a bottom side). When mounted to the cage 332 via the axle 328, the caster wheel 324 extends below the bottom edge of the cage 332 to engage the track 308 (FIG. 15). As shown, the caster wheel 324 extends around opposing sides of the track 308. The rear wall 332D of the cage includes apertures 336 that receive threaded fasteners 340 for coupling the cage 332 (and the caster wheel 324) to the wall 300 of the extension 172 (via apertures 416 in the wall 300, FIG. 29). As shown, three fasteners 340 are arranged vertically along the rear wall 332D.

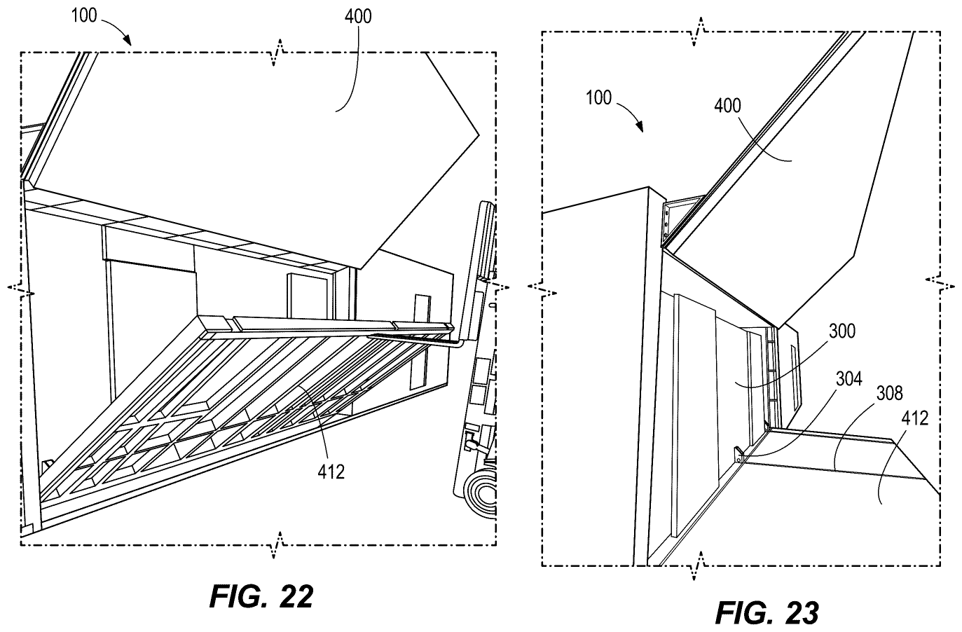

FIG. 14 illustrates the track 308 along which the caster 304 is slidable. The track is sunk or recessed into the floor 412 of the imaging unit 100 and includes a central protrusion 344 around and/or on which the caster wheel 324 runs to control linear travel of the wall 300 relative to the remainder of the imaging unit 100. As a portion of the floor 412 is lowered down (FIGS. 22-23) during assembly, to form the floor of the extension 172, a first portion of the track 308 is located within a first portion of the floor and a second portion of the track 308 is located within a second portion of the floor (FIG. 15), the second portion of the floor being rotatable relative to the first portion during assembly of the extension 172. The caster 304 is within the first portion of the track 308 in the stowed position, as shown in FIG. 15, and passes over the second portion of the track 308 to reach an installed position (FIG. 9).

As shown in FIG. 9, three (or more) tracks 308 are arranged along a length of the wall 300 and are arranged parallel to one another, each supporting a caster wheel 324 thereon. The caster wheels 324 each simultaneously ride along the tracks 308 to move the wall 300 from the stowed position (FIG. 15) to the installed position (FIG. 9). The tracks 308 are removable once the wall 300 has been slid into position and the recesses within the floor 412 that hold the tracks are filled with a material similar to the remainder of the floor 412 to provide a seamless finished appearance. In other embodiments, the tracks 308 can remain in place and simply be covered.

FIGS. 15 and 33 illustrate a further plan view of the mobile imaging unit 100, illustrating the extension 172 mid-installation, with the floor 412 of the extension 172 lowered down, but the walls of the extension 172 not yet assembled. Various interior walls and doors are folded into the open space that will form the control room 108 (FIG. 7) to provide room for the exterior wall 300 coupled to the casters 304 to be located within the interior volume of the imaging unit 100 during transport. The wall 300 is not only located within the interior volume during transport but is also bolted into place to prevent movement of the wall 300 along the tracks 308 during transport. The interior wall 348 (that extends between the two uptake rooms 116 located within the extension 172 when in the installed position) and the shielded doors 320 may also be movable along a track 308 from a stowed position (FIG. 15) to a use position (FIG. 9).

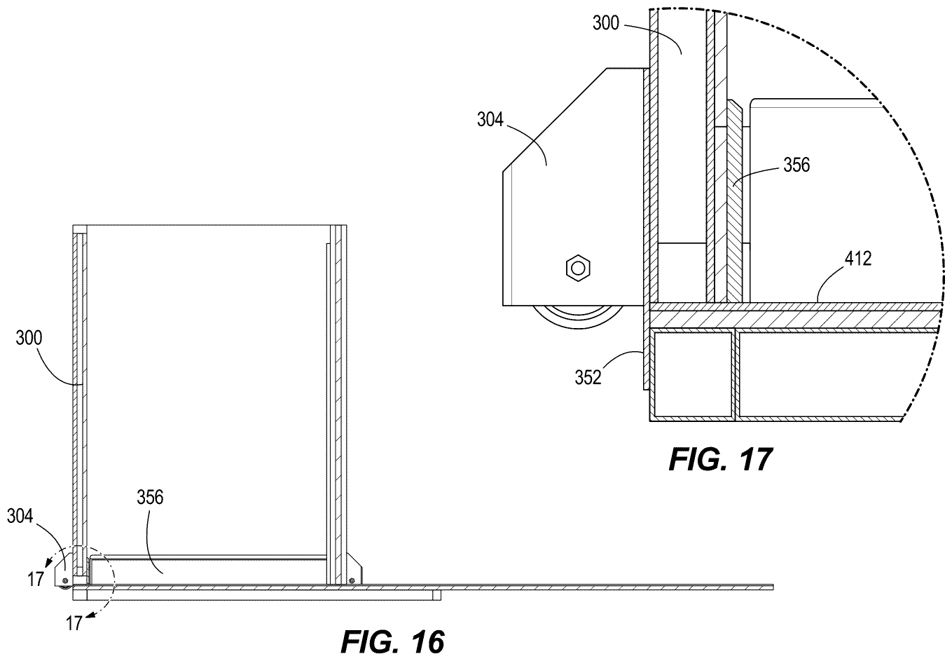

FIGS. 16-17 illustrate the caster 304 mounted to the wall 300 when the wall 300 is in the installed position. As shown, the caster 304 extends beyond an outer edge of the floor 412 and has dropped off the track 308 such that the wall 300 rests directly upon (i.e., is in direct contact with) the floor 412. This results in no air gap, reducing radiation and heat loss. In comparison, the wall 300 is spaced apart from the floor 412 when the caster 304 is on the track 308 to facilitate movement of the wall 300 relative to the floor 412. A plate 352 mounted to the floor 412 extends upward from the floor 412 and functions as a stop to prevent movement of the wall 300 beyond the installed position. The caster 304 is removed from the wall 300 (by removing the fasteners 340 from the wall 300 when the wall 300 is in the desired location to provide a flat outer wall surface.

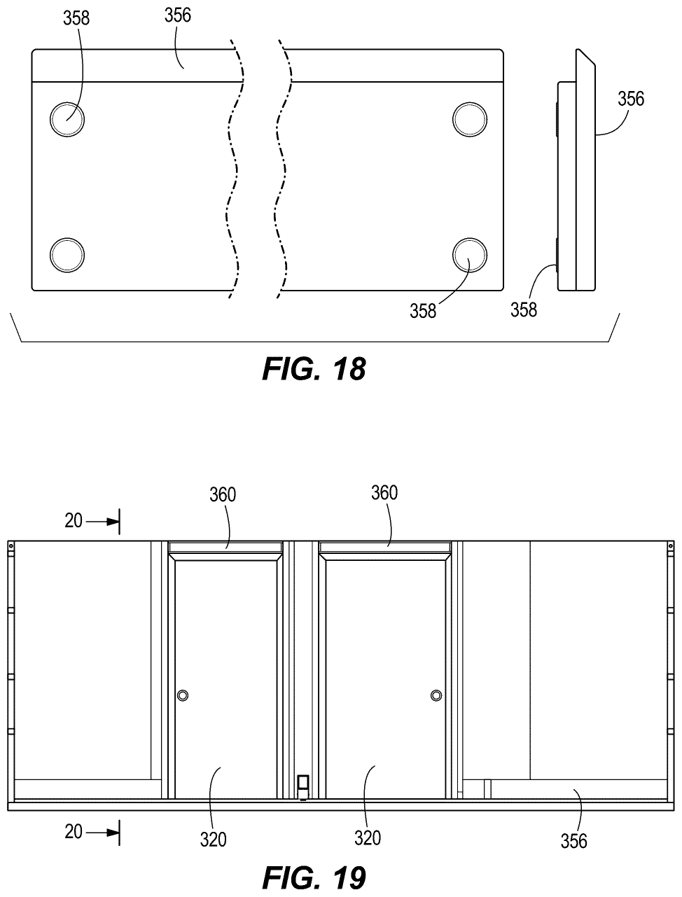

As shown in FIGS. 18-19, a lead shielded baseboard 356 is added to each of the walls (such as wall 300) at the seam between the wall and the floor 412 to cover the interface. As shown in FIG. 18, each of the baseboards 356 may include a plurality of magnets 358 that couple to the metal frame of the wall and allow for easy removal of the baseboard 356 to access the frame there behind. FIG. 23 also illustrates that in some embodiments, transom windows 360 may be included above the doors 320 for improved lighting and aesthetics.

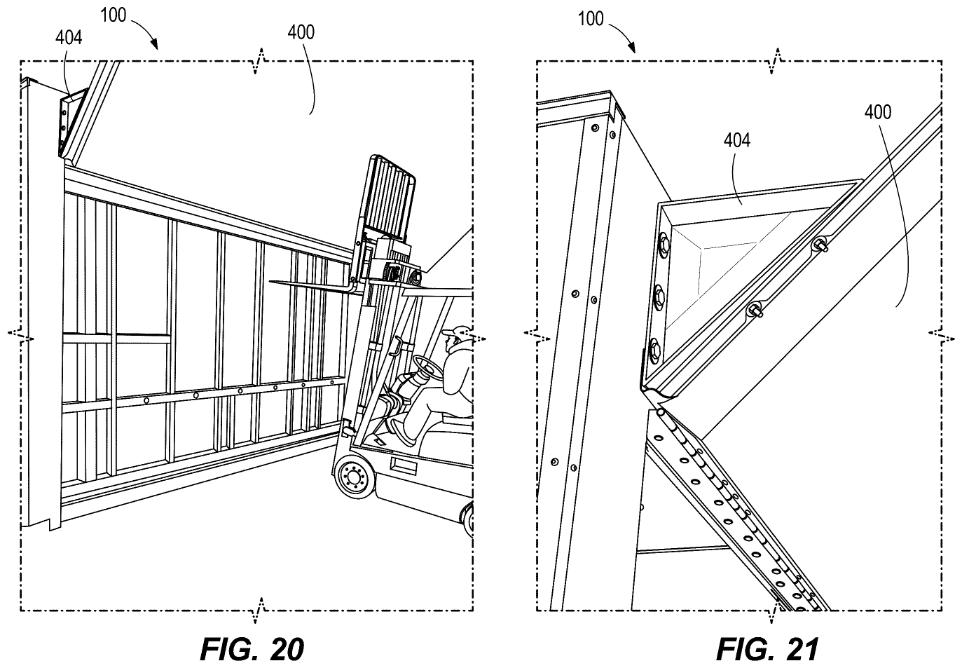

FIGS. 20-32 illustrate an assembly method of the extension 172 from the stowed or transit/transportation position for transportation to the extended position for use. FIG. 20 illustrates an installer lifting an awning or ceiling 400 upward, rotating the awning 400 about one or more hinges located along a side of the unit 100. As shown, the awning 400 is rotated more than ninety degrees (e.g., 120-150 degrees, approximately 135 degrees) such that it is not a horizontal ceiling in this raised position. In some embodiments, the awning 400 defines an outer sidewall of the unit 100 in the transport position. In other embodiments, the awning 400 may be located within the unit 100 during transport. As shown in greater detail in FIG. 21, the awning 400 is supported in the raised position by a plurality (e.g., two) of awning support brackets 404 that are substantially triangular brackets extending from the side of the unit 100. Fasteners such as threaded fasteners extend through the bracket 404 and into the awning 400 to hold the awning 400 in the raised position. With the awning 400 in the raised position, it is significantly out of the way to provide for movement of the floor 412 and walls (including wall 300) into position.

FIG. 22 illustrates the stage or floor 412 being lowered by an installer from a raised position (for transportation) to a lowered position. In some embodiments, the floor 412 is lowered onto support structures depending on a height of the ground surface below the floor 412 when the floor 412 is horizontal. The floor 412 includes an appropriate number and configuration of structural beams to rigidly support the walls, doors, and other equipment housed in the extension 172. The floor 412 is nested behind the ceiling 400 in the stowed transport position and is rotatable about an axis that is parallel to a rotational axis of the ceiling 400, though the two axes are spaced apart from one another as the awning 400 rotates up and the floor 412 rotates down.

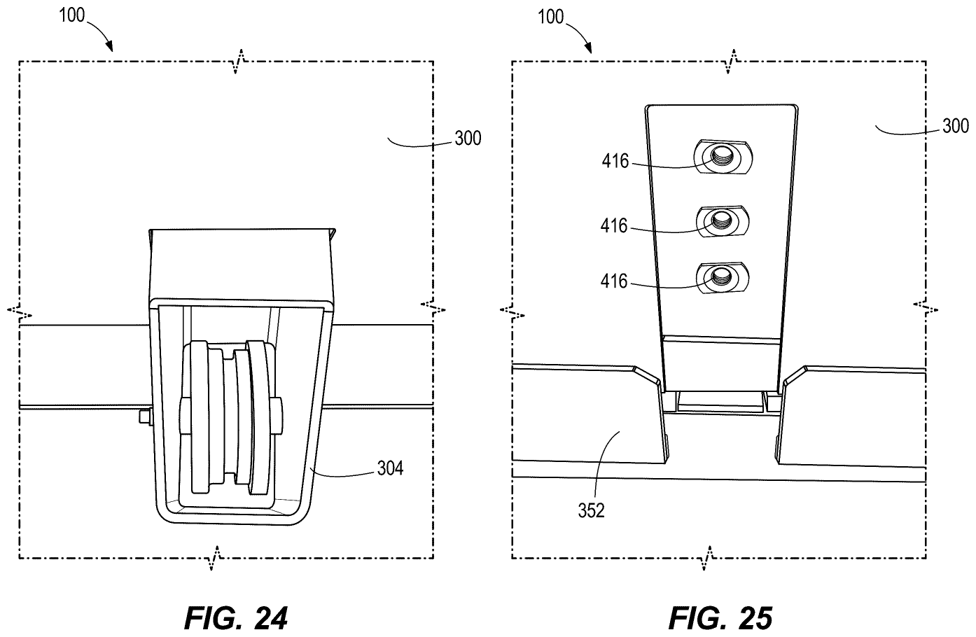

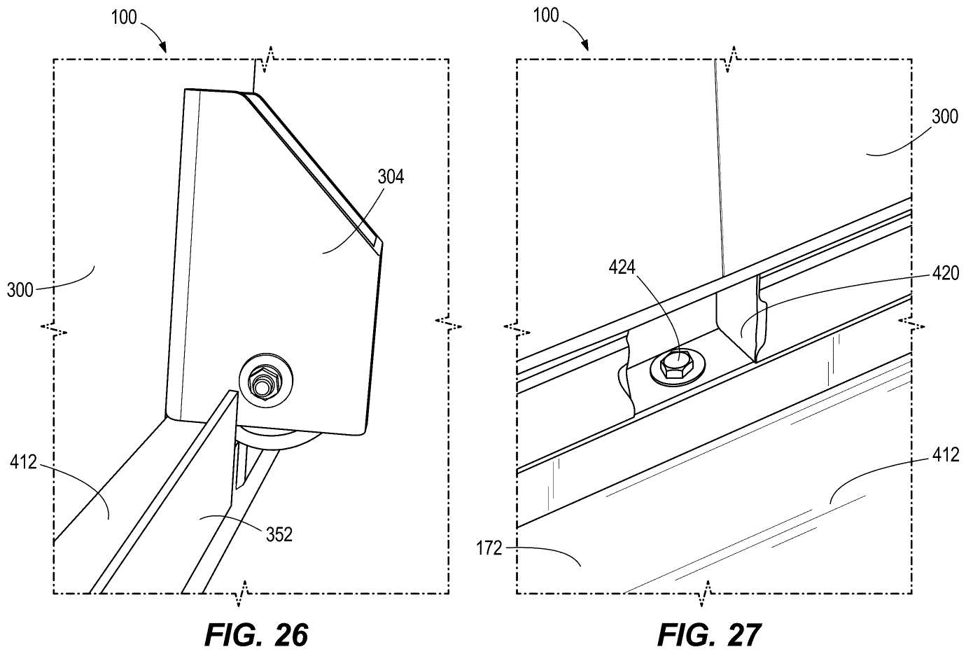

FIG. 23 illustrates the wall 300 in the stowed position with the floor 412 lowered and the tracks 308 installed within the floor 412. The casters 304 are aligned with the tracks 308 and ready to move the wall 300 outward along the floor 412. FIG. 24 illustrates the caster 304 in greater detail and FIG. 25 illustrates the point on the wall 300 that receives the caster 304, including the apertures 416 for mounting the caster 304 to the wall 300. The casters 304 are moved by the installer along the tracks 308 until the wall 300 reaches an installed position in which the casters 304 drop off the tracks 308 and hang off the floor 412, as shown in FIG. 26, thereby increasing the footprint of the imaging unit 100 relative to the smaller footprint (FIG. 33) when the imaging unit 100 was in transit.

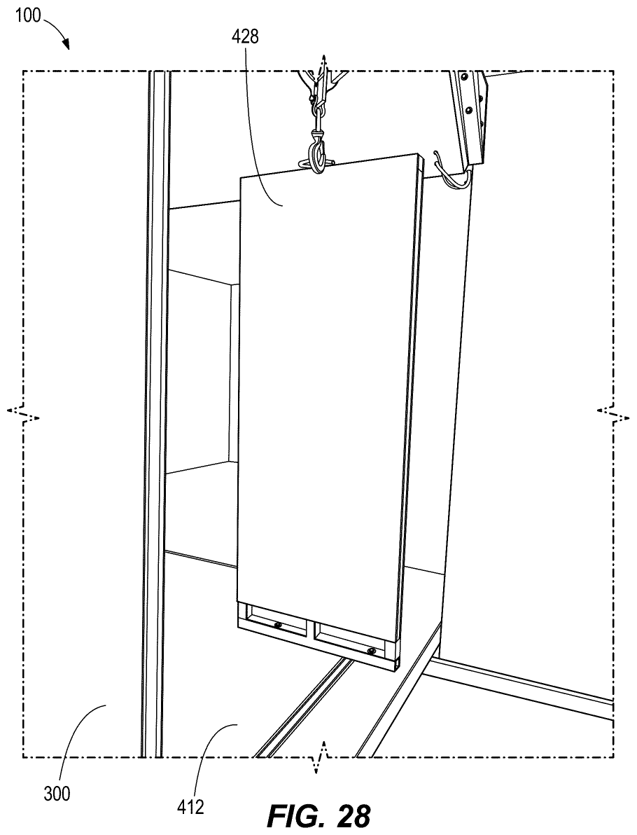

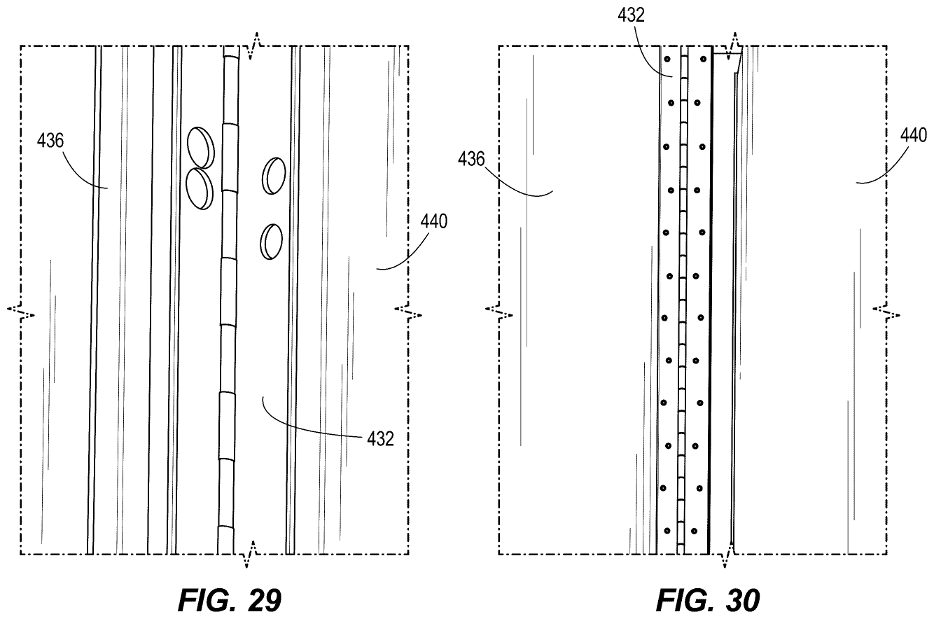

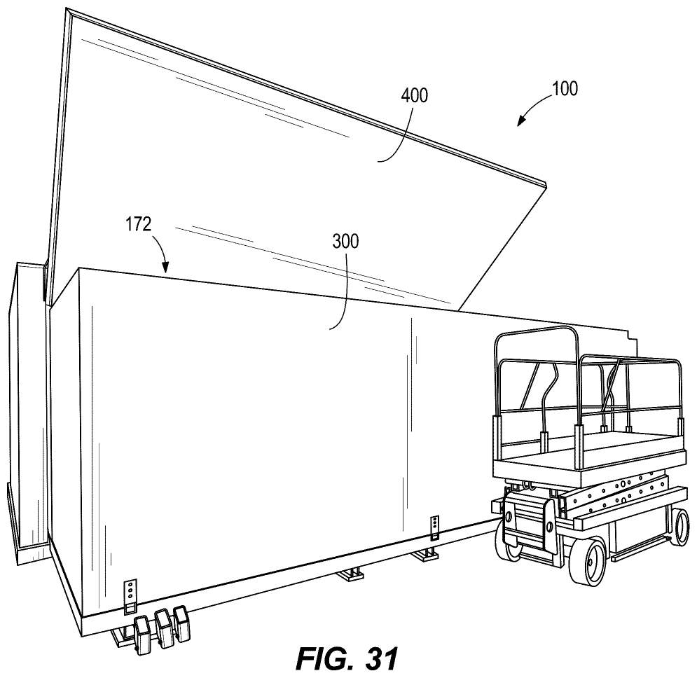

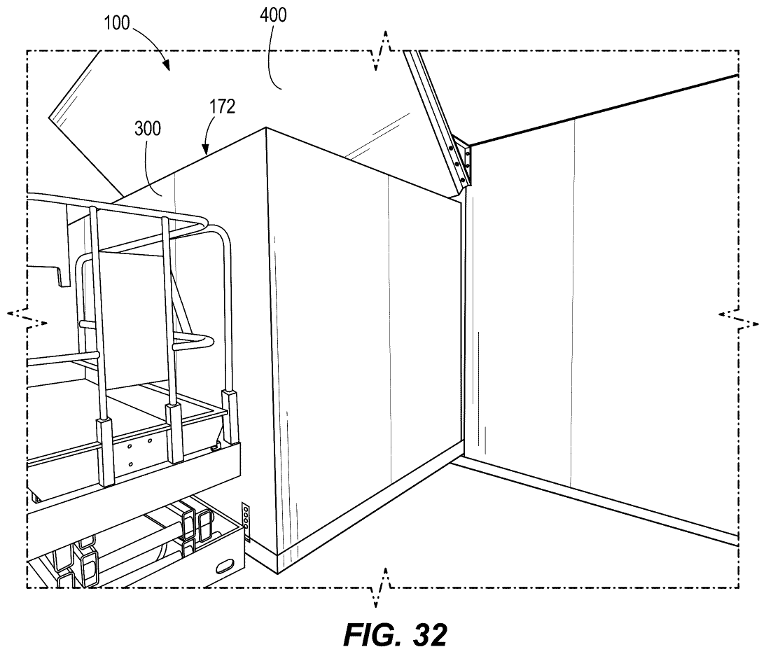

FIG. 27 illustrates an interior of the wall 300 when in the installed and deployed position. Openings 420 adjacent the base of the wall 300 and spaced apart along a length of the wall 300 provide space for a fastener 424 (e.g., a threaded fastener such as a bolt) to be inserted through the wall 300 and into the floor 412 to secure the wall 300 in place relative to the floor 412. As shown in FIG. 28, additional wall sections 428 (e.g., three wall sections) are lifted and dropped into place. These additional wall sections 428 are attached to the floor 412 via a similar fastener 424 as is used to attach the sliding wall 300. Other wall sections are rotated into location, as is shown in FIG. 19. FIGS. 29-30 illustrates an interior hinge 432 between two wall sections 436, 440 that facilitates rotation of one wall relative to another between a folded position (FIG. 29) and a deployed position (FIG. 30). FIGS. 31 and 32 illustrate the extension 172 with all walls secured in position. The walls, including the movable wall 300 on the casters 304, as well as (at least some of) the wall sections 428 lowered into place, are external walls of the mobile imaging unit 100 in the installed position, even though they are not external walls while the unit 100 is in transit. These walls at least partially define an extent of the interior of the mobile imaging unit 100, and in the illustrated embodiment, at least partially define an extent of the interior of two of the uptake rooms 116.

Once all walls are in position, the T-brackets 312 and L-brackets 316 are secured at the intersections of two walls to secure the adjacent walls to one another at the tops of the walls. Additionally, the baseboards 356 are placed along the base of each wall, covering the fasteners 424. The awning 400 is uncoupled from the awning support brackets 404 and lowered against the top of the walls of the extension 172 to form a ceiling. In some embodiments, the awning 400 may be horizontal in the lowered, use position. In other embodiments, the awning 400 may have a downward pitch extending away from the remainder of the imaging unit 100 to assist with water runoff. The walls of the extension 172 may include a matching pitch or, alternatively, additional panels may be placed between the side walls and the awning 400 to seal and insulate the extension 172. The awning support brackets 404 may then be removed from the imaging unit 100 and the openings that coupled the brackets 404 to the unit 100 may be covered by a cover panel (not shown).

Although the invention has been described in detail with reference to certain preferred embodiments, variations and modifications exist within the scope and spirit of one or more independent aspects of the invention as described.

What is claimed is:

1. A mobile imaging unit configured for transport between a first location and a second location, the mobile imaging unit comprising:
a base configured to rest upon a ground surface that is external to the mobile imaging unit, the base extending from the ground surface to a floor of the mobile imaging unit;
a plurality of walls extending upward from the base to define an interior of the mobile imaging unit therebetween, the interior of the mobile imaging unit having an imaging room housing an imaging unit, and a control room having a workstation from which the imaging unit is controllable, wherein the plurality of walls includes a movable wall;
a track coupled to the base; and
a caster coupled to the movable wall and movable with the movable wall along the track from a stowed position to an installed position to increase a width of the mobile imaging unit.

2. The mobile imaging unit of claim 1, wherein the track is a first track and the caster is a first caster, the mobile imaging unit further comprising a second track coupled to the base and extending parallel to the first track, and a second caster coupled to the movable wall and movable along the second track from the stowed position to the installed position.

3. The mobile imaging unit of claim 1, wherein, in the installed position, the caster is coupled to the movable wall and spaced apart from the track.

4. The mobile imaging unit of claim 3, wherein, in the installed position, the caster is located outside of the interior of the mobile imaging unit.

5. The mobile imaging unit of claim 1, wherein, when the caster is in the stowed position, the movable wall is spaced apart from the base, and when the caster is in the installed position, the movable wall is in direct contact with the base.

6. The mobile imaging unit of claim 1, wherein the movable wall is located within the interior of the mobile imaging unit when the caster is in the stowed position, and wherein the movable wall is an exterior wall at least partially defining an extent of the interior of the mobile imaging unit in the installed position.

7. The mobile imaging unit of claim 1, wherein a first portion of the track is located within a first portion of the floor and a second portion of the track is located within a second portion of the floor, wherein the second portion of the floor is rotatable relative to the first portion of the floor.

8. The mobile imaging unit of claim 7, wherein the caster is located within the first portion of the track in the stowed position, and wherein the caster is configured to pass over the second portion of the track to reach the installed position.

9. The mobile imaging unit of claim 1, wherein the plurality of walls includes a wall section coupled to the base when the movable wall is in the installed position, the wall section coupling the movable wall to a remainder of the plurality of walls.

10. The mobile imaging unit of claim 9, further comprising a bracket coupling the wall section to the movable wall to secure the movable wall in the installed position.

11. The mobile imaging unit of claim 1, wherein the interior of the imaging unit further comprises a plurality of uptake rooms, each of the plurality of uptake rooms having a seat for a user of the mobile imaging unit to wait for a radiotracer to travel through the user to a location that is to be scanned by the imaging unit, wherein the movable wall at least partially defines an extent of an interior of the plurality of uptake rooms in the installed position.

12. A mobile imaging unit configured for transport between a first location and a second location, the mobile imaging unit comprising:
a base configured to rest upon a ground surface that is external to the mobile imaging unit, the base extending from the ground surface to a floor of the mobile imaging unit, the base having a first footprint when transported from the first location to the second location and a second footprint when in an installed position;
a plurality of walls extending upward from the base to define an interior of the mobile imaging unit therebetween, the interior of the mobile imaging unit having:
an imaging room housing an imaging unit for a patient;
a control room having a workstation from which the imaging unit is controllable; and
a plurality of uptake rooms, each of the plurality of uptake rooms having a seat for the patient to wait for a radiotracer to travel through the patient to a location that is to be scanned by the imaging unit; and
an extension forming a portion of the interior of the mobile imaging unit that extends outward from the first footprint of the base, the extension movable relative to a remainder of the mobile imaging unit between a stowed position and an installed position.

13. The mobile imaging unit of claim 12, wherein the extension includes a movable wall of the plurality of walls, the movable wall being movable between a stowed position and an installed position via a caster coupled to the movable wall.

14. The mobile imaging unit of claim 13, wherein the movable wall at least partially defines an extent of an interior of the plurality of uptake rooms in the installed position.

15. The mobile imaging unit of claim 12, wherein at least a portion of the extension is coupled to the base within the interior of the first footprint when transported from the first location to the second location.

16. A method of assembling a mobile imaging unit from a transport position to a use position, the method comprising:
transporting the mobile imaging unit from a first location to a second location and resting a base of the mobile imaging unit on a ground surface at the second location;
raising a wall of the mobile imaging unit to form a ceiling of an extension;
lowering a surface within the mobile imaging unit to form a floor of the extension;
sliding a wall on casters along the floor of the extension from a location within an interior of the mobile imaging unit to an edge of the floor of the extension to form an external wall of the extension, thereby increasing a footprint of the mobile imaging unit in the use position relative to the transport position.

17. The method of claim 16, wherein the wall that is raised to form the ceiling of the extension is an external wall of the mobile imaging unit when the mobile imaging unit is transported from the first location to the second location.

18. The method of claim 16, wherein sliding the wall on casters includes moving the casters along a track formed at least partially within the floor of the extension.

19. The method of claim 18, wherein the track extends into a floor of the mobile imaging unit that is separate from the extension such that moving the casters along the track includes moving the casters from the floor of the mobile imaging unit that is separate from the extension onto the floor of the extension.

20. The method of claim 16, further comprising sliding the casters off of the floor of the extension to lower the wall onto the floor of the extension.
